(19) United States
(12) Patent Application Publication
(10) Pub. No.: US 2013/0119659 A1
(43) Pub. Date: May 16, 2013

(54) SINGLE AXIS PUSH TO CONNECT CONDUIT FITTING

(71) Applicants: Peter C. Williams, Cleveland Heights, OH (US); Cal R. Brown, Lyndhurst, OH (US); Mark A. Clason, Orwell, OH (US); Gergory S. Kalata, Avon, OH (US); Harry Slaven, Canfield, OH (US); Justin Hamilton, Lakewood, OH (US); Ronald Hamilton, Cleveland, OH (US); Daniel G. Trivett, Mayfield Heights, OH (US)

(72) Inventors: Peter C. Williams, Cleveland Heights, OH (US); Cal R. Brown, Lyndhurst, OH (US); Mark A. Clason, Orwell, OH (US); Gergory S. Kalata, Avon, OH (US); Harry Slaven, Canfield, OH (US); Justin Hamilton, Lakewood, OH (US); Ronald Hamilton, Cleveland, OH (US); Daniel G. Trivett, Mayfield Heights, OH (US)

(73) Assignee: Swagelok Company, Solon, OH (US)

(21) Appl. No.: 13/811,918

(22) PCT Filed: Jul. 25, 2011
(86) PCT No.: PCT/US11/45145

§ 371 Date: Jan. 24, 2013

Related U.S. Application Data
(60) Provisional application No. 61/367,644, filed on Jul. 26, 2010.

(51) Int. Cl. F16L 37/088

(52) U.S. Cl. CPC F16L 37/088
USPC 285/374

(57) ABSTRACT

A push to connect conduit fitting includes a first fitting component and a second fitting component and a releasable retaining structure for retaining the two fitting components in one or more retained axial positions as an unthreaded mechanical connection. In one of the retained axial positions a conduit may be inserted and a conduit retainer holds the conduit in position. A seal mechanism may also be provided to seal an outer surface of the conduit fitting assembly. Embodiments for a threaded mechanical connection are also disclosed.

### RELATED APPLICATION

The present application claims the benefit of pending U.S. provisional patent application serial number 61/367,644 filed on Jul. 26, 2010 for RAPID ASSEMBLY CONDUIT FITTING, the entire disclosure of which is fully incorporated herein by reference.

### TECHNICAL FIELD OF THE DISCLOSURE

The present disclosure relates to fittings for metal conduits such as metal tube and pipe. More particularly, the disclosure relates to fittings that can be assembled with a conduit by a push to connect action.

### BACKGROUND OF THE DISCLOSURE

Fittings are used in gas or liquid fluid systems to provide a fluid tight mechanical connection between a conduit and another fluid flow device, such as another conduit, a flow control device such as a valve or regulator, a port and so on. A particular type of fitting commonly used is known as a flareless fitting that uses one or more conduit gripping devices such as ferrules, for example, to provide the conduit grip and seal functions. Such fittings are popular as they do not require much preparation of the conduit end, other than squaring off and de-burring. High performance conduit fittings typically involve a threaded connection wherein the fitting is pulled-up or tightened by relative rotation of turns and partial turns between two threaded mating components. Moreover, the conduit gripping devices typically become attached to the conduit exterior surface and remain on the conduit after disassembly of the mating parts.

### SUMMARY OF THE DISCLOSURE

In accordance with an embodiment of one or more of the inventions presented in this disclosure, conduit fitting concepts are disclosed that facilitate assembly by using either a push to connect method or a push to assemble and cinch method. The former may be used with non-threaded connections and the latter may be used with threaded connections. In either approach, a conduit end may be inserted into an un-tightened or loosely assembled fitting assembly and retained in place prior to final tightening. In a particular embodiment, a separate tool may be used to allow the conduit to be removed from the loose assembly without complete separation of the constituent parts, but in an alternative embodiment for the tool, the tool may be integral with a conduit retention mechanism. In other embodiments, one of the mating fitting components provides structure by which the conduit may be removed without complete separation of the constituent parts.

In another embodiment, two mating fitting components may be connected together with a conduit end such that a seal mechanism provides a fluid-tight seal without permanently gripping the conduit end. In one embodiment, a seal member optionally is elastically deformed under load when the mating fitting components are tightened together, and elastically releases or unloads from the tube when the mating fitting components are loosened but not necessarily completely disassembled or separated. This allows for the conduit to be removed from the loosened fitting assembly and reinserted for subsequent reassembly.

In still further embodiments, intrinsic gauging features may optionally be provided with the conduit fitting assembly to provide a visual indication to the assembler whether the fitting assembly is in a loosened or tightened condition. In additional embodiments, for threaded connections, structure may optionally be provided to facilitate tightening or pull-up of the fitting using turns or torque. In additional embodiments, a seal mechanism may be provided that is a discrete seal, a discrete seal held with one of the mating fitting components as a cartridge or subassembly, or a seal that is integral with one of the mating fitting components.

In all embodiments, the seal mechanism may optionally include metal, non-metal or composite type seal members.

These and other embodiments of various inventions disclosed herein will be understood by those skilled in the art in view of the accompanying drawings.

### BRIEF DESCRIPTION OF THE DRAWINGS

FIG. 1 illustrates a first embodiment of one or more of the inventions herein, in longitudinal cross-section;

FIG. 2 is the assembly of FIG. 1 with a conduit captured in the assembly;

FIG. 3 is the assembly of FIG. 2 in a fully tightened position;

FIG. 4 is the assembly of FIG. 3 in a loosened condition;

FIG. 5 is the assembly of FIG. 4 with a tool inserted;

FIG. 6 is the assembly of FIG. 5 with the conduit partially withdrawn from the assembly;

FIG. 7 is an embodiment of a push to connect fitting;

FIG. 8 is the assembly of FIG. 7 with a conduit captured in the assembly;

FIG. 9 is the assembly of FIG. 8 in a fully tightened position;

FIG. 10 is the assembly of FIG. 9 in a partially loosened position;

FIG. 11 is the assembly of FIG. 10 with a tool inserted;

FIG. 12 is the assembly of FIG. 11 with the conduit withdrawn from the assembly;

FIG. 13 is the assembly of FIG. 12 with the insert partially withdrawn from the body;

FIG. 14 is an alternative embodiment showing a cartridge arrangement for a seal mechanism and insert;

FIG. 15 is an alternative embodiment showing an integral tool and conduit retaining ring in a partially loose fitting assembly;

FIG. 16 illustrates the assembly of FIG. 15 in a tightened position;

FIG. 17 is an alternative embodiment showing a shaped retaining ring; and

FIG. 18 is an embodiment of a push to connect male fitting in the fully assembled position, shown in longitudinal cross-section.

### DESCRIPTION OF THE EXEMPLARY EMBODIMENTS

Although the exemplary embodiments herein are presented in the context of a stainless steel tube fitting, the inventions herein are not limited to such applications, and will find use with many different metal conduits such as tube and pipe as well as different materials other than 316 stainless steel, and may also be used for liquid or gas fluids. Although the inventions herein are illustrated with respect to a particular design of the conduit seal and gripping devices and fitting components, the inventions are not limited to use with such designs. The inventions may be used with tube or pipe, so we use the term “conduit” and “fluid conduit” to include tube or pipe or both. We use the term “fluid conduit” to include conduits that contain a flow of or pressurized fluid, whether the fluid is liquid, gas or a slurry. Fluid conduit does not include sheaths and protective covers, for example, and may be used with electrical cables, optic cables and so on. We also use the terms “conduit” and “fluid conduit” to refer to tube or pipe which are cylindrical bodies with generally smooth exterior and interior end surfaces. We do not include within the term “conduit” or “fluid conduit” the concept of a fluid containing part or component that has a formed or machined geometry other than generally cylindrical tube or pipe. We generally use the terms “fitting assembly” and “fitting” interchangeably as a shorthand reference to an assembly of typically first and second fitting components along with one or more conduit seal and gripping devices. The concept of a “fitting assembly” thus may include assembly of the parts onto a conduit, either in a finger-tight, partial or complete pull-up position; but the term “fitting assembly” is also intended to include an assembly of parts together without a conduit, for example for shipping or handling, as well as the constituent parts themselves even if not assembled together. Fittings typically include two mating fitting components that are joined together, and one or more conduit seal and gripping devices, however, the inventions herein may be used with fittings that include additional pieces and parts. For example, a union fitting may include a body and two nuts. We also use the term “fitting remake” and derivative terms herein to refer to a fitting assembly that has been at least once tightened or completely pulled-up, loosened, and then re-tightened to another completely pulled-up position. Remakes may be done with the same fitting assembly parts (e.g. nut, body, conduit seal and gripping devices), for example, or may involve the replacement of one of more of the parts of the fitting assembly. Reference herein to “outboard” and “inboard” are for convenience and simply refer to whether a direction is axially towards the center of a fitting (inboard) or away from the center (outboard), referenced to the central longitudinal axis X of the fitting assembly. All references herein to “radial” and “axial” are referenced to the X axis except as may otherwise be noted. Also, all references herein to angles are referenced to the X axis except as may otherwise be noted.

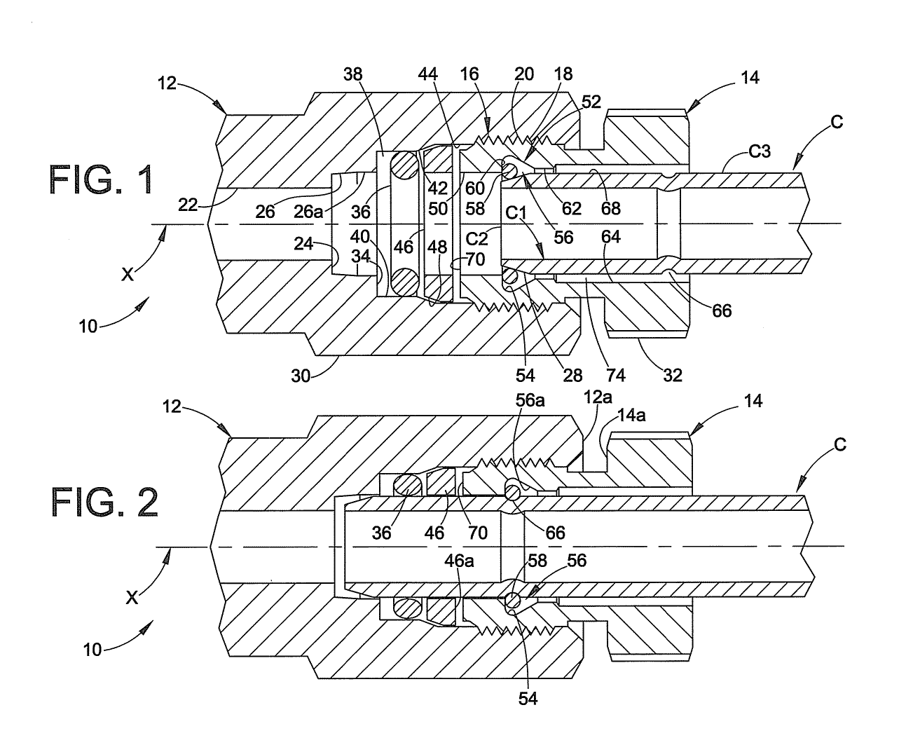

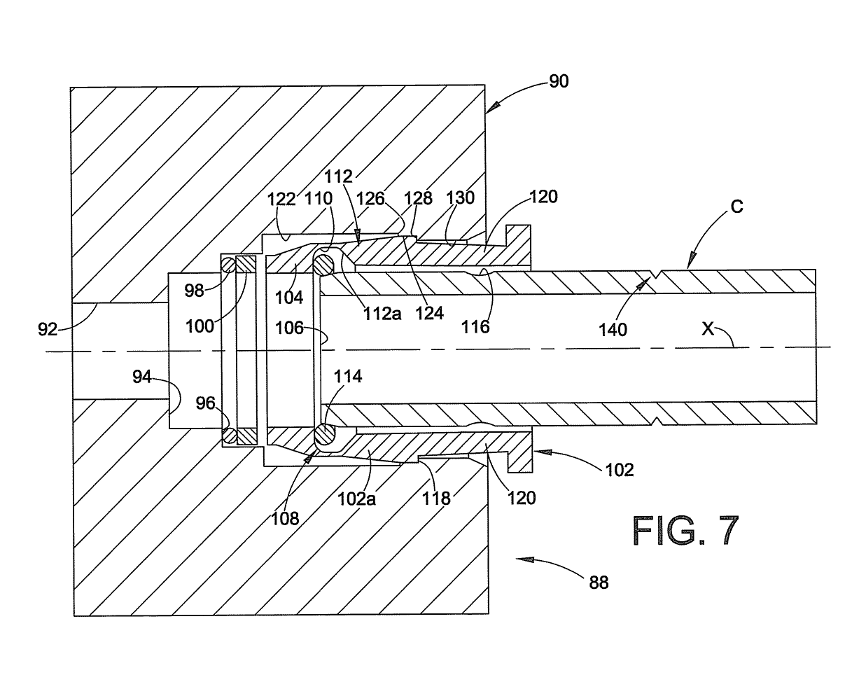

The embodiments we illustrate herein take on two basic inventive configurations. In the first configuration, the mating fitting components are threadably joined together to make a mechanical connection, but the conduit end can initially be axially inserted into the pre-assembled fitting assembly and retained therein (in contrast to a customary tube fitting for example in which the conduit can be axially inserted into a loosely assembled fitting assembly but also is releasable in that the conduit may also be axially removed if the fitting assembly has not been pulled-up). Final tightening or cinching of the first configuration then will also include a relative rotation between the mating fitting components, somewhat akin to a “pull-up” of a customary fitting component. We will sometimes refer herein to this configuration as a push to assemble and cinch or push to capture and cinch configuration. FIGS. 1-6 exemplify an embodiment of this configuration, which may employ an axis for linear movement to insert the conduit C into the assembly, and a torque or rotational movement to cinch the fitting assembly to a final tightened position. The rotational movement is preferably about the same axis as the linear movement. The second configuration involves an assembly of parts that can be pushed axially together to form a preassembly, and then tightened or cinched to a final position by further relative axial displacement preferably along the same axis. We will sometimes herein refer to this configuration as a push to connect or push to cinch configuration as there need not be any threaded connections between the mating fitting components, and final assembly and tightening or cinching can be accomplished by straightforward axial movement, preferably single axis movement. FIGS. 7-14 exemplify embodiments of the configuration. As with the first configuration, a conduit retainer is preferably releasable so that when the first and second fitting components are mechanically connected at a first retained axial position relative to each other, the conduit may be axially withdrawn. In both configurations, an optional tool may be used to facilitate axial withdrawal of the conduit from the mechanical connection.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions--such as alternative materials, structures, configurations, methods, circuits, devices and components, alternatives as to form, fit and function, and so on--may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

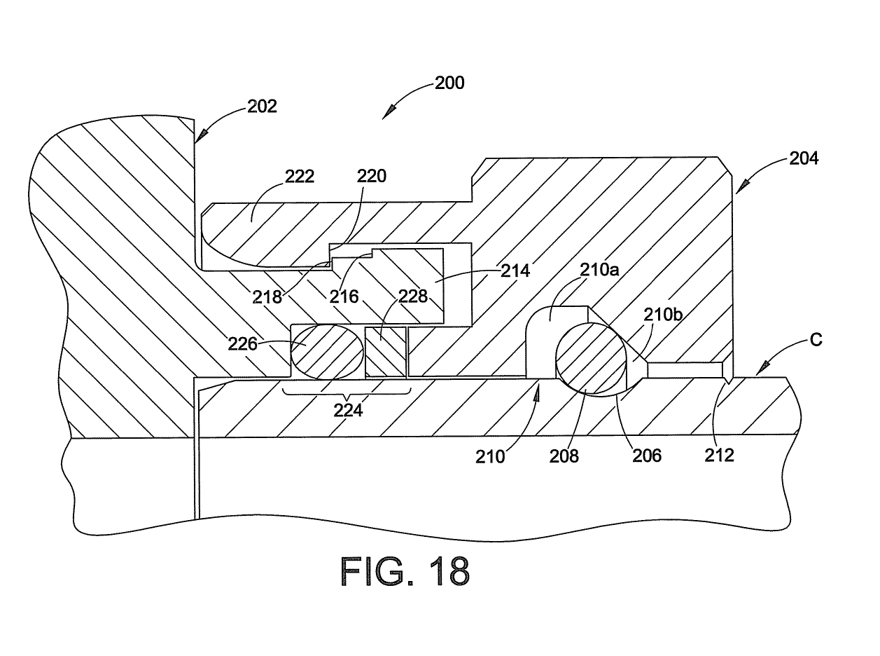

With reference to FIGS. 1-6 and initially FIG. 1, a first embodiment of one or more of the inventions is presented. In this example, a conduit fitting assembly 10 for tube or pipe C includes a first fitting component 12 and a second fitting component 14. As examples, we also refer to these parts as a body and nut respectively, wherein the body 12 receives a conduit end portion C1, and the nut 14 may be joined to the body 12 during make up of the fitting. Although we use the common teems of body and nut herein as a convenience, those skilled in the art will appreciate that the inventions are not limited to applications wherein such terminology may be used to describe the parts. The body 12 may be a stand-alone component as illustrated or may be integral with or integrated or assembled into another component or assembly such as, for example, a valve, a tank or other flow device or fluid containment device. The body 12 may have many different configurations, for example, a union, a tee, an elbow and so on to name a few that are well known in the art. Fittings are also commonly referred to in the art as male fittings or female fittings, with the distinction being that for a male fitting the male body 12 includes an externally threaded portion and the female nut 14 includes an internally threaded portion. For a female fitting, the male nut 12 includes an externally threaded portion and the female body 14 includes an internally threaded portion. Most of the embodiments herein are female-type fittings, however, those of ordinary skill in the art will be readily able to use the teachings herein to use the one or more inventions with a male fitting such as, for example, in FIG. 18. The female body 12 herein is also commonly known in the art as a port body or female port because its entire structure can be although need not be recessed in or formed in another body and a connection can still be made.

The fitting embodiments herein will find particular application in the automotive industry, however, they may be used anywhere there is a need for fluid pressure containment. As an example, the inventions herein may be used to realize an automotive fitting for containing rated gas pressures (for example, for methane) of about 3000 to about 3500 psi with performance as high as 5000 psi or greater. The fittings herein may be scaled to accommodate conduits such as nominal outside diameters of ⅛ inch or less up to and greater than ½ inch (and metric equivalents), for example. These values are only intended to be exemplary and not any limitation on the use or scope of the inventions disclosed herein. For automotive applications and others, the ported body 12 may comprise aluminum alloy, for example.

As noted, the body 12 is commonly understood as being the fitting component that receives an end C1 of a conduit C. The nut 14 is commonly understood as the fitting component that mates with the body. In FIG. 1, the fitting 10 includes a threaded connection 16 as with internal threads 18 on the body 12 and external threads 20 on the nut 14 (reference numerals 16, 18 and 20 are only provided on FIG. 1). FIGS. 1-6 therefore illustrate an exemplary embodiment of the first configuration type referred to herein as a push to capture and cinch.

The terms “complete pull-up” or “complete tightening or cinching” as used herein refers to joining the fitting components together (whether it is a threaded or non-threaded connection) to create a fluid tight seal and grip of the fitting assembly 10 on the conduit C. A pre-assembly or pre-assembled position as used herein is one in which the fitting components are loosely or partially assembled before conduit insertion and such that a conduit end can be inserted into the loose assembly and retained therein. This position is exemplified in FIG. 1. We also refer to an initial or first pull-up or make-up to refer to the first time that a fitting is tightened to a complete pulled-up or cinched position. A subsequent pull-up or remake refers to any complete pull-up after a previous pull-up, whether that previous pull-up was the initial pull-up or a later pull-up or remake of the fitting.

We also refer to the term “loosely assembled” and derivative forms to refer to an assembly of parts that are held together but have not been fully tightened together. We intend the term to include parts that have been joined to a finger-tight condition or even snugged a bit but not tightened to the extent of full seal compression.

The body 12 may include a fluid bore 22 for fluid communication with the conduit C, or may simply be a blind port or cap. A body 12 commonly includes a counterbore that provides a shoulder or other surface 24 against which the conduit end wall C2 bottoms. The use of a counterbore shoulder, however, is not required in all designs. In customary conduit fittings, it is usually desirable to have the conduit bottom against this shoulder 24, however, in the embodiments herein such bottoming may be less than complete because the conduit is provided with separate means for verifying that the conduit is fully inserted. A first tapered wall or surface 26 that tapers radially outward in the inboard axial direction may optionally be provided to interface with a tapered end surface 28 near the conduit end to facilitate centering and alignment and insertion of the conduit end C1 into the body 12. The tapered wall 26 may be frusto-conical for example, although other profiles may alternatively be used. This optional interface may also provide a conduit capture feature to help assist in withdrawing the conduit C from the body during disassembly after a completed pull-up of the fitting 10. Alternatively, the wall 26 may be fully cylindrical. The wall 26 also may include an adjacent cylindrical portion 26a that closely receives the outer surface C3 of the conduit C (see FIG. 2 for example).

The body 12 (when used as a standalone component) is commonly provided with wrench flats 30 and the nut is commonly provided with wrench flats 32 to aid the assembler in pulling up the fitting 10. Although either fitting component 12, 14 may be rotated, usually an assembler uses a wrench to hold the body 12 stationary while using another wrench to turn the nut 14. Or alternatively, sometimes the body 12 is held in a fixture, and in other applications the body 12 is already installed or integrated with another structure, for example, for female ported fittings.

A second counterbore 34 is provided that has a somewhat larger diameter than the first counterbore 24. A first seal element or member 36 may be disposed in the recess of the second counterbore 34. The first seal element 36 may be realized in many different forms and shapes, and in the exemplary embodiment is realized in the form of an o-ring. The first seal element 36 may be made of any material that is compatible with the system fluid contained by the fitting 10. For many gasses and liquids we use a VITON™ elastomer but many other materials are available including plastics, polymers and soft metal seals. When the conduit end C1 is inserted into the first counterbore 24, for example FIG. 2, the o-ring 36 is radially compressed between the outer surface C3 of the conduit and the axial wall 40 of the second counterbore 34 to provide a fluid-tight seal between the conduit C and the body 12 (note in the various figures herein that interference between two surfaces may be represented by overlap of the parts rather than showing any compression which actually occurs).

Axially adjacent the axial wall 40 of the second counterbore 34 is an optional second tapered wall or surface 42. The second tapered wall 42 tapers radially outward in the inboard axial direction. The second tapered wall 26 may be frusto-conical as one example. The second tapered wall 42 adjoins a cylindrical major inner wall 44 in which the female threads 18 of the body 12 may be machined.

A second and optional seal element 46 may be provided just inboard of the first seal element 36. The first and second seal elements may be considered to form a seal mechanism although in many applications a single seal element may be used and in others perhaps additional seal elements may be needed. In this embodiment, we use the second seal element 46 as a backing ring to diminish extrusion of the first seal element 36, particularly when the fitting 10 is under pressure. We therefore select the second seal 46 material to be somewhat stiffer than the first seal 36, for example PEEK™ but again many materials are available and well known. The optional second tapered surface 42 may be used to radially compress the second seal element 46 between the body 12 and the outer surface C3 of the conduit. This compression will strengthen the second seal element 46 to perform as a backup or backing ring to reduce extrusion of the typically softer first seal element 36. The radial compression of the second seal element 46 may also allow the second seal element 46 to provide a backup or secondary seal against fluid pressure should the first seal 36 allow fluid to bypass. To facilitate the radial compression of the second seal element 46, we provide an optional chamfer or taper 48 that will coact with the second tapered wall 42 when the second seal 46 is axially pushed outboard toward the second counterbore 34 during tightening of the fitting 10. This axial movement is effected by the second fitting component or nut 14 as will be further explained hereinbelow.

The nut 14 or second fitting component includes a minor diameter bore 50 that closely receives the conduit end portion C1 during assembly. An interior groove in the form of a circumferential recess 52 is formed in this bore 50 and preferably has a profile in section (as shown in FIGS. 1-6) of having an inboard larger diameter portion 54 blending, such as by tapering, to a smaller diameter portion 56. A conduit retainer or retaining member 58 is provided that is dimensioned to be at least partially received in or sit in the recess 52. The conduit retainer 58 may be realized in many different forms including but not limited to a split ring, snap ring, scarfed wire, wire coil, set of arcuate wire sections, balls or gripper elements optionally attached to each other. In the exemplary embodiment, the conduit retainer 58 may be realized in the form of a radially expandable or elastic retaining ring 58, for example, a split metal ring or a ring made of elastic material. Many other shapes and members may alternatively be used. The conduit retainer or retaining member 58 may optionally be retained with the nut 14 but with freedom of movement within the nut 14. The retaining ring 58 preferably will have in inside diameter that is sized to be rather closely received over the outside surface C3 of the conduit, but also having an outside diameter that is sized to allow at least a portion of the retaining ring 58 to be expanded radially into the larger diameter portion 54 of the recess 52. The smaller diameter portion 56 of the recess 52 is dimensioned so as to engage the retaining ring 58 under certain conditions as further described below. Note that the smaller diameter portion 56 may be formed by using a tapered wall portion 56a of the recess 52. For example, the tapered wall 56a may be frusto-conical or other suitable profile or contour. The larger diameter portion 54 may be inboard bounded by a radial shoulder 60 so as to prevent the retaining ring 58 from being moved into the minor bore 50 of the nut. The outboard end of the recess 52 is bounded by an optional intermediate diameter bore 62 of the nut having preferably a somewhat larger diameter than the minor diameter bore 50 in order to accommodate a tool as will be further described hereinbelow. An optional major diameter bore 64 that is somewhat larger than the intermediate bore 62 diameter may be provided axially outboard of the intermediate bore 62 also to accommodate the tool described hereinbelow.

The conduit C is also provided with a retention groove or notch or other recessed shape 66 formed in the outer surface of the conduit C and that receives at least a portion of the retaining ring 58 as will be further described below. The recess 66 may be machined or, as shown in FIGS. 1-6 formed by a die (not shown) that radially deforms a portion of the conduit wall. The conduit groove 66 may be made to have any shape or contour that cooperates to retain the conduit retainer 58, the latter which may also take on many different shapes, configurations or designs. Functionally, the conduit groove 66 and the conduit retainer 58 cooperate so that the conduit C may be retained within the fitting 10 preferably prior to and after final cinching. This can be contrasted to a conventional tube fitting in which the conduit can be axially withdrawn prior to pull-up of the fitting (ferrule deformation into the conduit). As another alternative, for example, the conduit C may be formed with a raised portion, as distinguished from a recessed portion, that cooperates with a conduit retainer or retaining member.

FIG. 1 illustrates the conduit fitting assembly 10 in a loosely assembled position preparatory to inserting the conduit end C1. The first and second seal elements 36, 46 may be first inserted into the body 12 and the retaining ring 58 may be inserted into the nut 14. The nut 14 may be loosely threaded into the body 12 to form a loose or un-tightened threaded mechanical connection.

In FIG. 2 the conduit C has been axially pushed into the assembly 10 until the retaining ring 58 snaps into the conduit groove 66. This may be accompanied by an audible click or tactile release of resistance to insertion of the conduit C so that the assembler knows that the conduit has been properly inserted to this position. The conical or tapered end 28 of the conduit initially facilitates spreading the retaining ring 58 radially outward so as to allow the conduit C to be pushed therethrough. The radially enlarged portion 54 of the nut recess 52 accommodates this radial expansion of the retaining ring 58. The conduit slides in with the retaining ring sliding along the outer surface 68 of the conduit inboard of the conduit recess 66 until the conduit groove 66 axially aligns with the retaining ring 58, at which point the retaining ring snaps into the conduit groove 66. Note that in the position of FIG. 2 the seal mechanism 36, 46 need not be fully compressed.

After the conduit C has been inserted into the nut 14 as in FIG. 2, the conduit end is captured by the retaining ring 58. The reduced diameter portion 56 of the nut recess 52 prevents the conduit C from being axially withdrawn when an axial load is applied to the conduit C. At this point the conduit C can only be removed from the nut 14 by use of a tool (described hereinbelow).

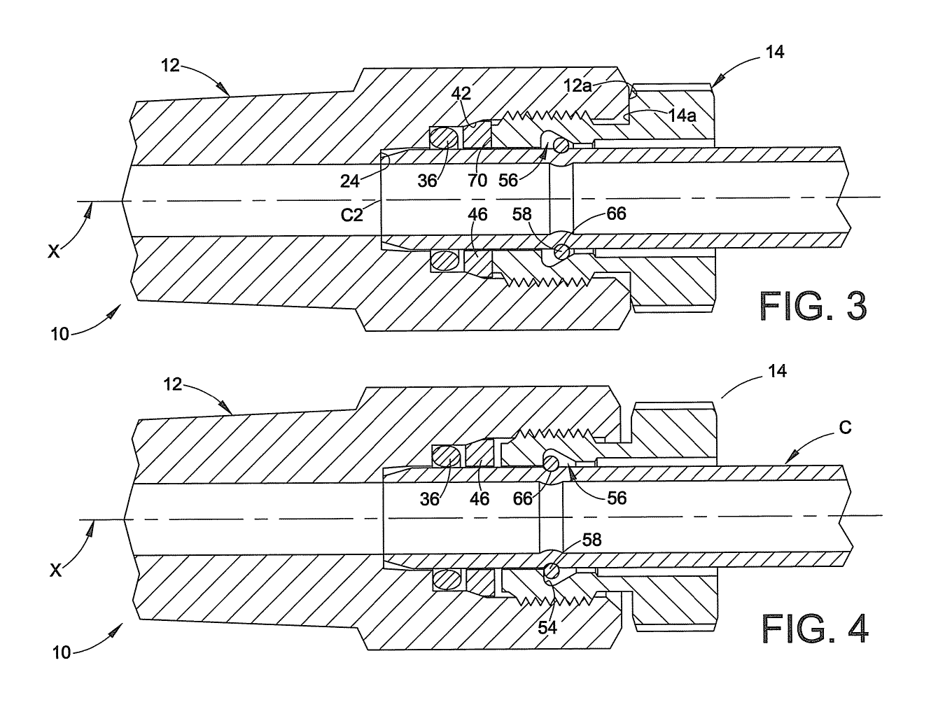

FIG. 3 illustrates the conduit fitting assembly after the nut 14 has been tightened or cinched with the body 12 to form a tightened threaded mechanical connection. This may involve as little as a quarter-turn or so of the nut 14 relative to the body 12. A distal inboard end 70 of the nut axially engages against a facing wall 46a (FIG. 2) of the second seal element 46, and axially pushes the second seal element 46 inboard and into engagement with the second tapered surface 42 of the body 14. This compresses the second seal element much in the nature of a packing so that the second seal element 46 reduces extrusion of the first seal element 36 and also may provide a secondary or backup seal function. The position in FIG. 3 then is a fully cinched and operational fitting that will contain system pressure.

Note in FIG. 3 that the relative axial displacement between the nut 14 and the body 12 during final tightening also aligns the conduit retaining ring 58 with the reduced diameter portion 56 of the nut recess 52. The tapered wall 56 may be dimensioned so that in the tightened position of FIG. 3 the retaining ring 58 is loaded against the conduit outer surface to add strength to the connection and reduce effects of vibration.

In order for the assembler to be able to verify that the fitting 10 has been properly cinched up, the nut 14 and body 12 may be axially dimensioned to provide a positive stop between facing ends 14a and 12a of the nut and body respectively. Use of the positive stop will prevent over-tightening and also be a direct indication to the assembler that the fitting 10 is fully tightened. Note that in the fully tightened position it is preferred but not required necessarily that the conduit end C2 bottom against the shoulder 24 of the body. Alternative means may be used to indicate to the assembler that the fitting 10 is fully tightened.

FIGS. 4-6 illustrate exemplary disassembly positions of the fitting 10. In FIG. 4 the nut 14 has been loosened from the body 12, preferably after system pressure has been removed. This loosening axially aligns the retaining ring 58 with the radially enlarged portion 54 of the nut recess 52.

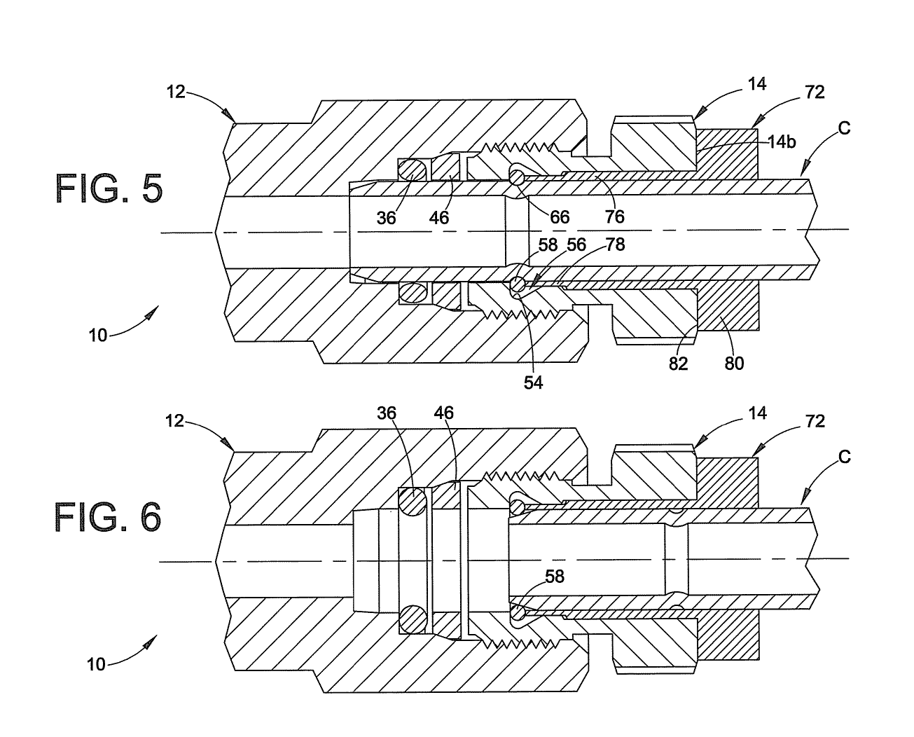

In FIG. 5 a tool 72 has been inserted through the annular space 74 (FIG. 1) between the conduit outer surface 68 and the nut major bore 64. The tool 72 may be any configuration that will allow insertion of either a cylinder 76 or prongs or legs to extend into the fitting to abut the retaining ring 58. Due to the intermediate diameter bore 62 in the nut, the tool may have an inboard reduced outer diameter portion 78. The tool 72 may be made of any metal or non-metal material and merely needs to be stiff enough to prevent the retaining ring 58 from being pulled backward (outboard) when an axial load is applied to the conduit C such that the conduit C may be axially withdrawn from the fitting assembly 10. The tool may be split or scarfed to allow wrap-around about the conduit C before insertion into the annular space 74.

FIG. 6 illustrates a position where the conduit has been released from the retaining ring 58 and partially axially withdrawn from the fitting 10. As the conduit C is axially pulled out, retaining ring 58 expands out of the conduit groove 66 due to alignment with the enlarged portion 54 of the nut recess 52, but is axially constrained by the tool 72. The tool 72 may have a head portion 80 with an inboard face 82 that bottoms against the back or outboard end 14b of the nut so that the assembler knows that the tool 72 has been fully inserted into the fitting assembly 10. Once the retaining ring 58 has been released from the conduit groove 66, the conduit C and the tool 72 may be easily axially withdrawn from the fitting assembly 10.

Thus, the exemplary embodiment of a push to capture and cinch fitting assembly 10 as in FIGS. 1-6 facilitate removal of the conduit C from the fitting assembly 10 without having to disassemble or separate the nut 14 from the body.

FIGS. 7-13 illustrate another embodiment of a fitting assembly 88, in this case an embodiment of a push to cinch configuration. A feature of the push to cinch configuration is that a mechanical connection can be made between the first and second fitting components (90, 102) and the conduit C, without a threaded connection. As will be described, the unthreaded mechanical connection may be realized with a retaining structure for releasably retaining the first and second fitting components together axially. In an exemplary embodiment, the retaining structure may provide a first retained axial position (e.g. for conduit insertion) and a second retained axial position (e.g. the cinched position). A releasable conduit retainer may also be provided for the push to cinch configuration. In this exemplary embodiment, the fitting assembly 88 includes a first fitting component or body 90 which may be, for example, a female port having a fluid bore 92 (alternatively the body 90 could omit the bore 92 and function as a cap), an optional conduit capture first counterbore 94 and a seal mechanism retaining second counterbore 96. The seal mechanism may comprise a first seal 98 and a retaining ring 100 such as in the first embodiment herein although different seal mechanisms may be used as needed.

The second fitting component or insert 102 does not have a threaded connection with the body 90, but can establish an unthreaded mechanical connection by an axial pushing action so as to produce relative axial displacement between the nut 90 and the insert 102. The insert 102 may be designed to perform the conduit capture function of the first embodiment in a somewhat similar fashion using a conduit retainer or retaining member, for example, a retaining ring.

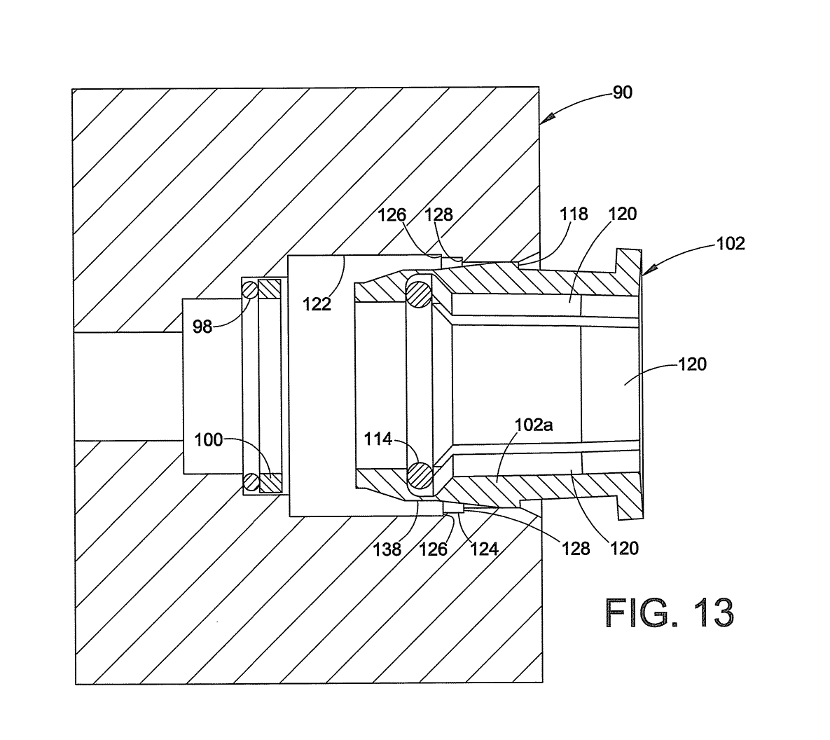

The insert 102 in this embodiment includes a body 102a with a forward nose portion 104 having an inboard distal end wall 106 that preferably will engage the second seal element 100 during cinching. Note in this embodiment the backing ring 100 may have a square cross-section, and the second counterbore 96 does not include a tapered wall. Alternatively, a configuration such as used in the first embodiment of FIGS. 1-6 or other may be used as needed. The body of the insert 102 further includes a recess or groove 108 having an enlarged diameter portion 110 and a reduced diameter portion 112 which may be provided, for example, with a tapered or conical wall portion 112a. A conduit retainer or retaining member, such as a radially expandable retaining ring 114 may be dimensioned as to expand into the groove 108 under certain conditions and to position into a conduit groove 116 in other positions. The insert groove 108, retaining ring 114 and conduit groove 116 cooperate to capture the conduit C in much the same manner as the first embodiment above. The insert 102 further may include an outboard facing retaining surface such as, for example, a shoulder 118 (best shown in FIG. 13). As will be apparent from the figures, the insert 102 may have a configuration that facilitates a radial compression of at least a portion of the body 102a of the insert 102 to permit insertion and removal of the insert 102 without a threaded engagement. Thus, in one embodiment, the insert body 102a may have a plurality of flexible members such as, for example, radially compressible members in the exemplary form of a plurality of cantilevered or flexible legs or segments 120 (see FIG. 13 also) that can be radially compressed so as to radially displace the shoulder 118. But alternatively as few as one flexible member 120 may be used and other design options may be utilized to provide a releasable mechanical connection.

The body 90 further includes a major diameter bore 122 and an axially adjacent smaller diameter step 124 to form a first retaining surface such as a shoulder for example, in this embodiment a cinch position retaining shoulder 126; and a second retaining surface such as a shoulder for example, in this embodiment a conduit capture shoulder 128 (also see FIG. 13). The first and second surfaces such as shoulders 126, 128 are axially separated from each other.

FIG. 7 illustrates the fitting assembly 88 preparatory to conduit insertion. The first and second seal elements 98, 100 have been inserted into the body 90, and the insert 102 has been axially pushed into the body 90 until the insert shoulder 118 engages the conduit capture shoulder 128. During the initial insertion, the flexible legs or segments 120 have been radially compressed due to engagement with the outboard bore 130 which has a diameter that is less than the diameter of the major diameter bore 122. When the shoulder 118 engages the capture shoulder 128 the assembler may hear an audible click. In this position of FIG. 7 the insert 102 is retained in the body 90 so long as the assembler does not compress the legs 120 to release engagement of the surfaces 118, 128 in order to remove the insert 102. FIG. 7 is thus an example of a first retained axial position of the first fitting component 90 relative to the second fitting component 102. The engaging or axially retaining surfaces 118, 128 are an exemplary embodiment of a retaining structure for a first retained axial position, and in an exemplary fashion a releasable retaining structure.

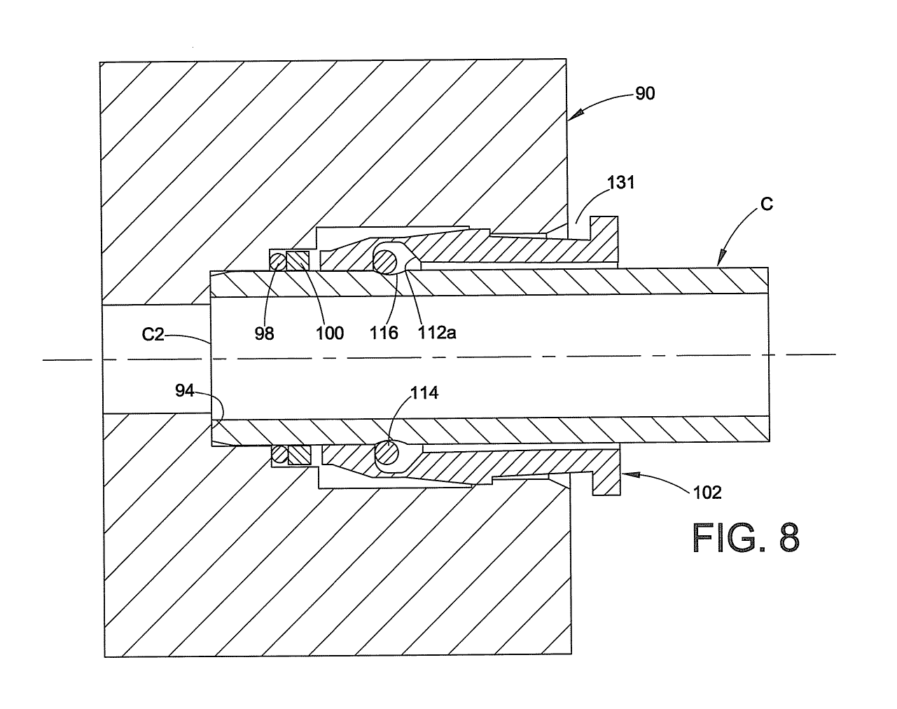

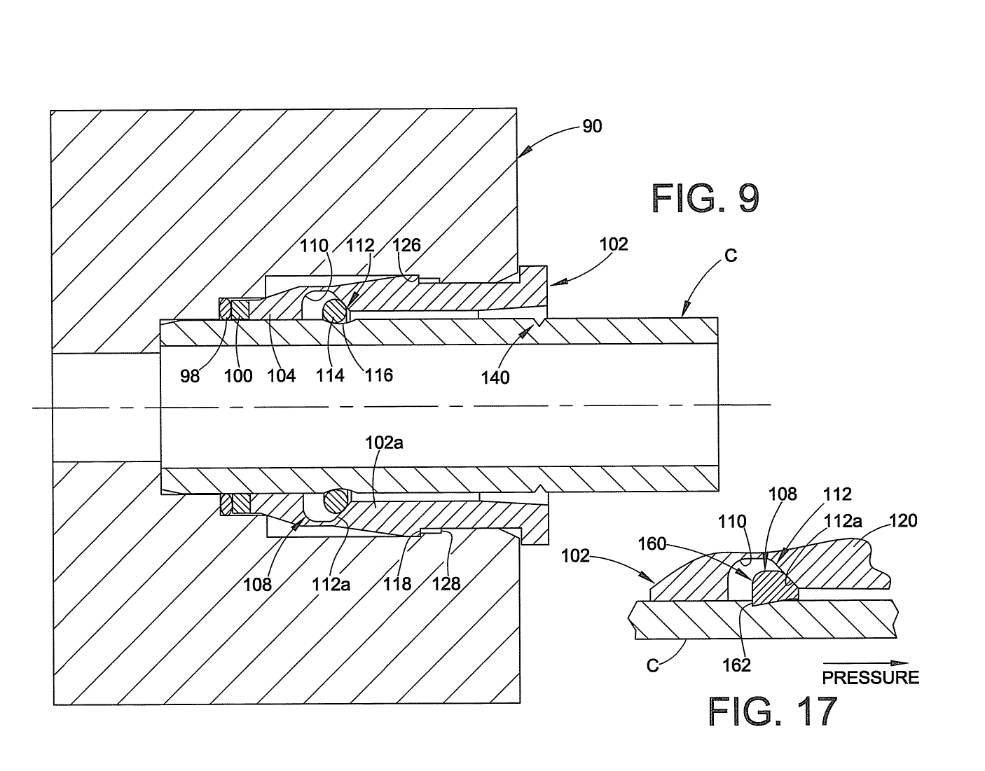

In FIG. 8 the conduit C has been axially inserted into the fitting assembly 88 preferably until the assembler detects that the conduit end C2 has bottomed on the first counterbore shoulder 94. In this position, the conduit groove 116 axially aligns generally with the enlarged diameter portion 110 of the insert groove 108 and the retaining ring 114 has slipped into the conduit groove 116. The conduit C is now captured in the fitting assembly 88 and cannot be pulled out axially even with an axial load applied thereto under normal use (i.e. a use such as an applied axial load that is not intended to defeat the retainer) until the retaining ring 114 is also released from the conduit groove 116. The conduit retainer 114 therefore opposes or resists axial withdrawal of the conduit C during normal use when the fitting assembly 88 is in the first (or second) retained axial position until the conduit retainer 114 is released from the conduit groove 116.

In order to cinch or tighten the fitting assembly 88 to its final position, as shown in FIG. 9 the insert 102 is axially pushed further into the body 90 until the insert shoulder 118 engages the cinch shoulder 126. Again, the assembler may hear an audible click or have tactile feedback. The engaging or axially retaining surfaces 118, 126 are an exemplary embodiment of a retaining structure for a second retained axial position. This further relative axial displacement between the insert 102 and the body 90 causes the distal end 106 of the insert to push on the second seal element 100 into position behind the first seal element 98. The second seal element 100 may be radially compressed in the nature of a packing to reduce extrusion of the first seal element 98 as well as may provide a secondary or backup seal function. The tightness of the connection between the insert 102 and the body 90 will indicate to the assembler that the fitting is fully cinched or tightened, as well as the visually perceptibly smaller gap 131 (see FIG. 8) between the back end of the insert 102 and the body 90. During use with system pressure in the cinched fitting assembly 88, preferably it will not be possible in normal use to collapse the insert legs 120 and withdraw the insert 102 position away from the cinch shoulder 126. FIG. 9 is thus an example of a second retained axial position of the first fitting component 90 relative to the second fitting component 102, and in an exemplary fashion a releasable retaining structure.

Although the exemplary embodiment of FIGS. 7-13 uses engaging surfaces such as shoulders between the body 90 and insert 102 to retain the insert in relative axial position, other techniques may alternatively be used for ease of manufacture. For example, another retaining ring and groove configuration may be used. Note again that in FIG. 9 the retaining ring 114 may be loaded between the tapered surface 112 and the conduit groove 116.

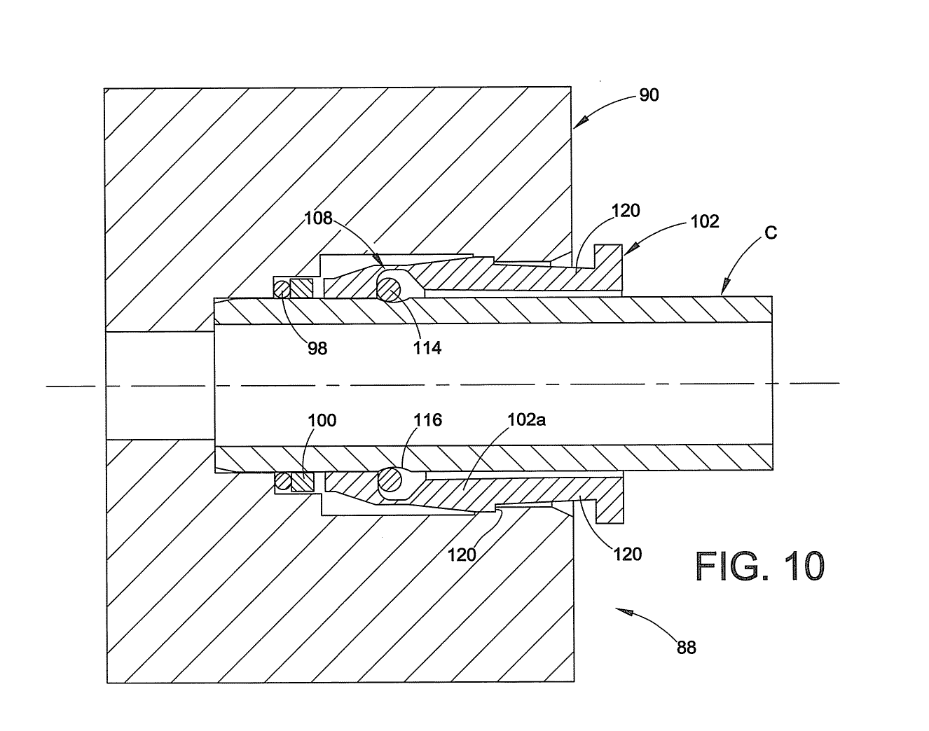

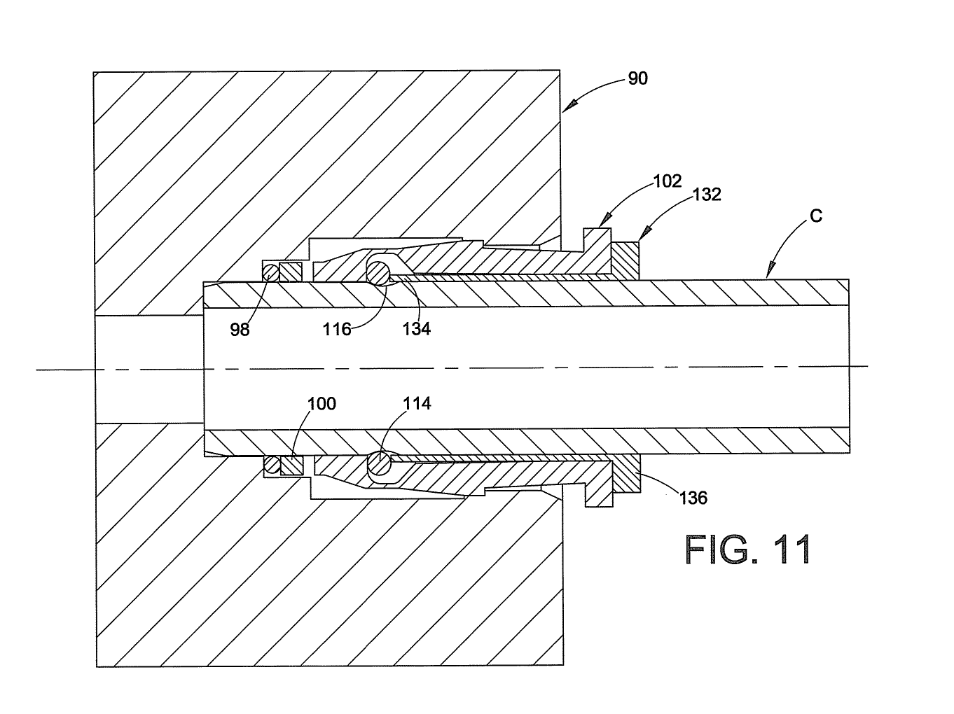

FIGS. 10-13 illustrate removal of the conduit and disassembly of the fitting 88. After system pressure is released, the insert 102 legs 120 may be compressed radially so as to displace the insert shoulder 118 away from the cinch shoulder 126 of the body. This allows the insert 102 to be axially backed out until the insert shoulder 118 engages the capture shoulder 128. This is the position illustrated in FIG. 10. In this position, the enlarged diameter portion 110 of the insert groove 108 generally axially aligns with the conduit groove 116 so that the retaining ring 114 is now free to radially expand so as to permit an axial load to be applied to the conduit C so that the conduit C may be withdrawn from the fitting assembly. Note that the insert legs 120 remain somewhat radially compressed in this position compared to FIG. 9 because of the reduced diameter of the step 124 in the body 90. Note further that from the viewpoint of the insert 102, this is the same retained axial position as FIG. 7.

In FIG. 11, an optional tool 132 has been inserted into the fitting assembly 88 and functions in much the same manner as the optional tool 72 described hereinabove. The primary purpose of the tool 132 is to hold the retaining ring 114 from backing up when the conduit C is withdrawn from the fitting assembly. The tool 132 thus may include a thin walled cylinder or legs 134 that extend forward to the retaining ring 114. The tool 132 may include a flange or head 136 that abuts the insert 102 to indicate to the assembler that the tool 132 is fully inserted. The tools 72, 132 are optional in that there will alternative ways to release the conduit retainer without a separate part called a tool.

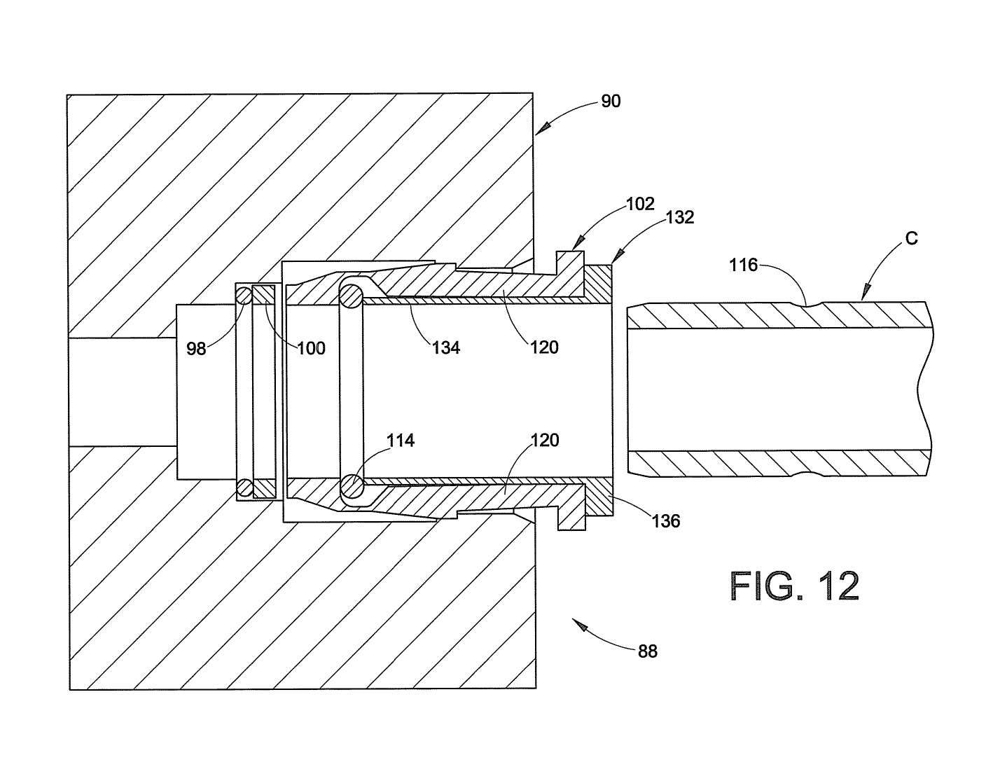

FIG. 12 shows the fitting 88 with the conduit C fully removed but the tool 132 has not been removed as yet. Thus the conduit C has been removed without having to fully disassemble or separate the insert 102 from the body 90. FIG. 13 illustrates that in order to remove the insert 102, the legs 120 may be further radially compressed to radially displace the insert shoulder 118 from the capture shoulder 128, which allows the insert 102 to be fully axially withdrawn from the body 90. Note that preferably the insert 102 cannot be removed from the body 90 while the conduit is disposed within the insert 102.

The insert 102 body may include a reduced thickness wall or neck 138 that joins the legs 120 to the continuous cylindrical nose portion 104. This neck 138 can assist in providing additional flexibility to the legs 120. Although in the exemplary embodiment we illustrate the use of three legs 120, more or fewer may be used.

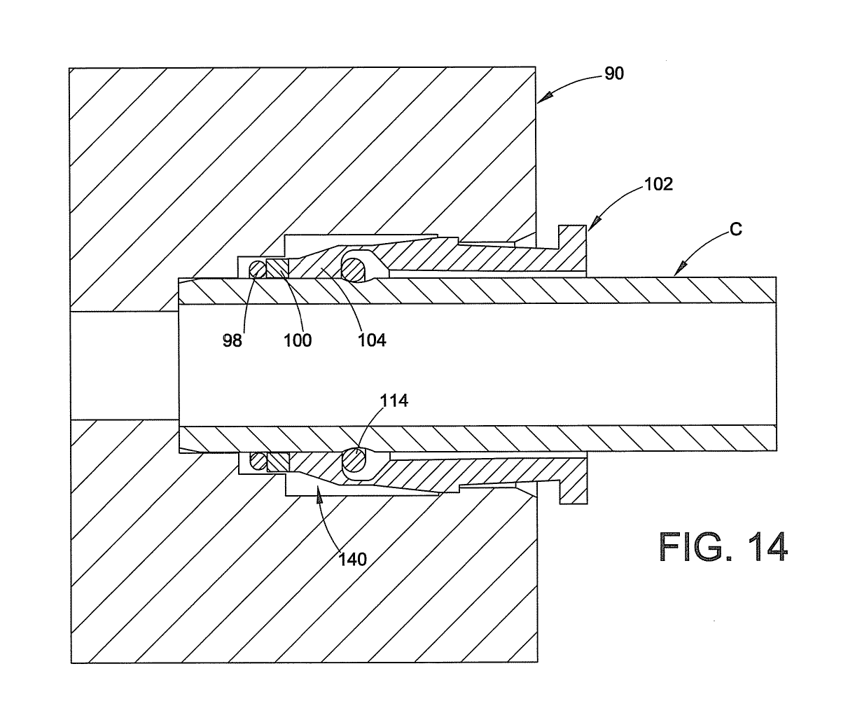

With reference to FIG. 14 we illustrate an alternative embodiment for the seal mechanism. In this case, the first and second seal elements 98, 100 may be integrally molded onto the distal or inboard end 106 of the insert 102. This simplifies assembly so that the seals do not have to be separately inserted into the body 90 before the insert 102 is inserted. The seals may also simply be joined to the insert 102 by a suitable adhesive or other convenient technique to form a seal mechanism/insert subassembly or cartridge 140 for insertion into the body 90. The cartridge concept may similarly be used with the embodiment herein of FIGS. 1-6.

For both embodiments discussed so far, and as shown in FIGS. 7 and 9, in an exemplary manner, the conduit C may also be provided with an intrinsic gauging feature such as, for example, a marking 140 such as a groove, line or other visually perceptible feature that becomes visually imperceptible when the conduit C is sufficiently inserted into the fitting 88. For example in FIG. 9 the marking 140 becomes hidden by the outboard end portion of the insert 102. For the first embodiment, the marking 140 could become hidden by the outboard end portion of the nut 14.

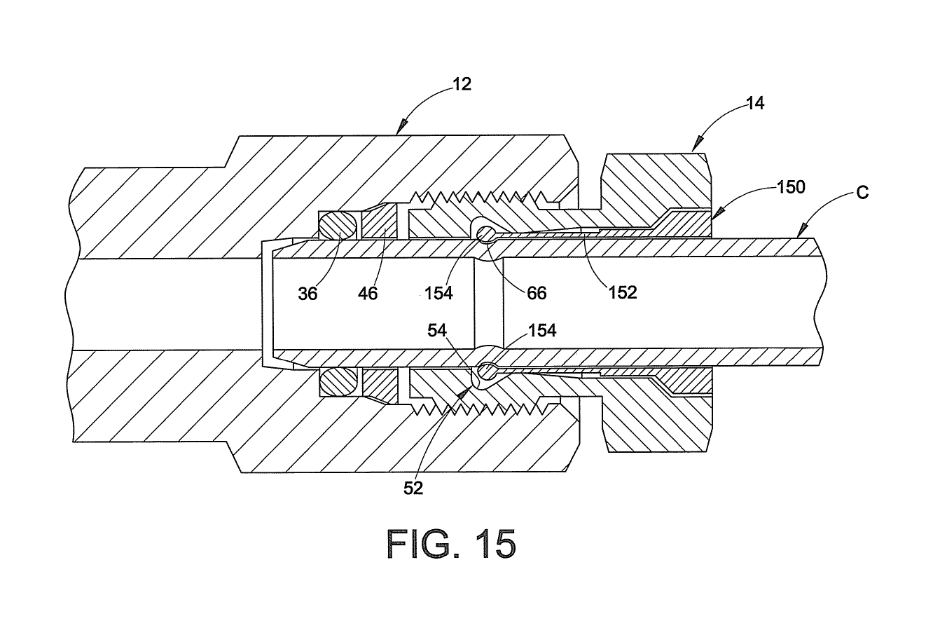

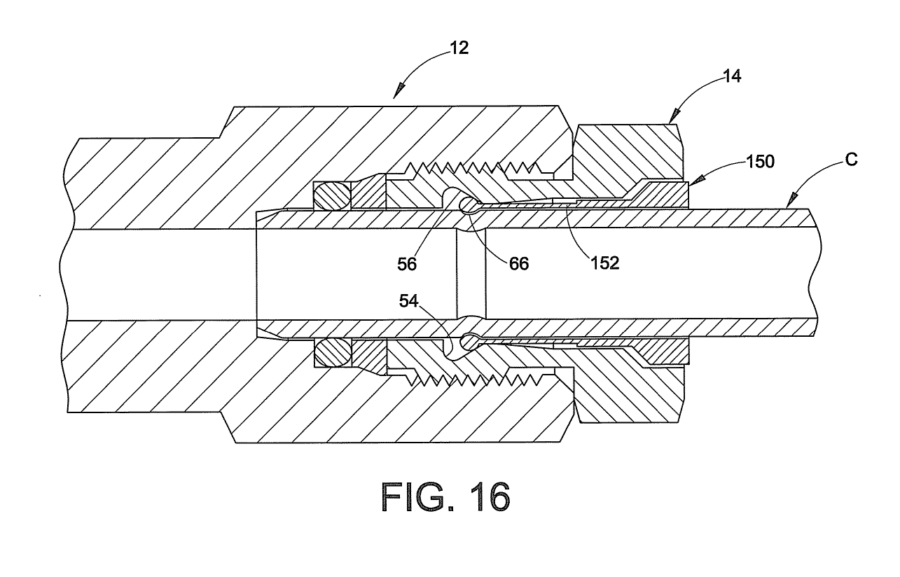

FIGS. 15 and 16 illustrate an alternative embodiment for the conduit retaining ring which may be used with either embodiment, although the drawings show the first embodiment and like reference numerals are used for like parts. In this example, a tool 150 is provided that includes flexible fingers 152 each with a bulbous or enlarged distal end or ends 154 that can function as the retaining ring. In the loosely assembled position of FIG. 15 the distal end 154 axially aligns with the enlarged portion of the nut groove 52 so that the conduit C can be inserted into the fitting. FIG. 16 illustrates that after the nut 14 has been tightened with the body, the distal end 156 is wedged between the reduced diameter portion 56 of the nut groove 52 and the conduit groove 66.

With reference to FIG. 17 we illustrate another optional feature for the conduit retaining ring. In this embodiment, the retaining ring 160 is a shaped ring rather than a simpler round ring. The conduit C may be provided with a formed indentation or shoulder 162 instead of a groove, against which the retaining ring 160 engages. After tightening, the retaining ring 160 becomes wedged between the conduit C and the tapered surface 112 of the insert recess 108. Under fluid pressure, the conduit C may be urged axially outboard of the fitting, but the retaining ring 160 will support the conduit C by engagement with the shoulder 162, and also be further wedged in between the tapered surface 112 and the conduit to withstand the fluid pressure effects on the conduit. This modified or shaped retaining ring concept may alternatively be used with all the embodiments herein. The shape of the retaining ring 160 and the engaging profile of the conduit C may be selected as needed for particular situations.

With reference to FIG. 18, as noted hereinabove, the two basic configurations of a push to capture and cinch fitting assembly and a push to connect or cinch fitting assembly may alternatively be realized in the foam of a male fitting assembly that uses a male ended body. FIG. 18 illustrates an example of a male style fitting assembly 200 for a push to connect configuration that provides an unthreaded mechanical connection with a conduit.

The fitting assembly 200 includes a first fitting component, in this example a male ended body 202 that can be push inserted into a second fitting component, in this example a female ended nut 204. A conduit C may be releasably captured in the fitting assembly 200 as in the other embodiments herein or alternatively other ways. In this example, the conduit C may include a groove or recess 206 formed in an outer surface of the conduit and that can receive a portion of a conduit retainer 208 such as a retaining ring.

The female nut 204 may include an interior groove or recess 210 having an enlarged portion 201a into which the conduit retainer 206 can radially expand so as to release the conduit C and a reduced portion 210b that interferes with removing the conduit C when the interior groove 210 and the conduit recess 206 are not radially aligned. Such is the position illustrated in FIG. 18.

An optional intrinsic gauging feature 212 such as a visible notch may be provided to indicate that the conduit C is captured and the fitting assembly is fully cinched.

The male body 202 may include an axially extending boss 214 having first and second shoulders 216, 218. The female nut 204 may include a shoulder 220 that is interior to an axial extension 222. The female nut shoulder 220 engages the first male body shoulder 216 to establish a first axially retained position and the second male body shoulder 218 to establish a second axially retained position (shown in FIG. 18).

A seal mechanism 224 may be provided as in the other embodiments including a first seal member 226 such as an o-ring and a backing member 228. The female nut 204 may include a second axial extension 230 that supports the seal mechanism 224 when the fitting assembly 200 is fully assembled or cinched as in FIG. 18.

The FIG. 18 configuration thus embodies the basic functions and features of the embodiments described above but in a male fitting configuration, including a releasable conduit retainer, an unthreaded mechanical connection using a releasable retaining structure, and a seal mechanism.

Note that from the position of FIG. 18, the conduit C can be axially withdrawn without use of a tool by moving the fitting components 202, 204 axially apart until the female shoulder 220 engages the first male shoulder 216. At this position, the interior recess 210 will generally radially align with the conduit groove 206, allowing the conduit retainer 208 to move into the enlarged portion 210a of the interior groove 210 which releases the conduit to be axially withdrawn while still maintaining the unthreaded mechanical connection between the fitting components 202, 204.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A push to connect fitting for fluid conduit, comprising:
a first fitting component that can receive an end of a fluid conduit,
a second fitting component that can be axially inserted into said first fitting component to form an unthreaded mechanical connection between said first and second fitting components,
a fluid conduit comprising a groove in an outer surface of the fluid conduit,
a retaining member that can be received in said fluid conduit groove,
a seal mechanism that seals an outer surface of the fluid conduit when the fluid conduit is fully inserted into said first fitting component.

2. The push to connect fitting of claim 1 wherein said groove comprises an arcuate recess.

3. The push to connect fitting of claim 1 wherein said retaining member comprises a radially expandable ring.

4. The push to connect fitting of claim 1 wherein said seal mechanism comprises an elastomer seal.

5. The push to connect fitting of claim 4 wherein said seal mechanism comprises an o-ring.

6. The push to connect fitting of claim 4 wherein said seal mechanism comprises a backing ring to reduce extrusion of said elastomer seal.

7. The push to connect fitting of claim 6 wherein said second fitting component comprises a distal end wall that supports said backing ring after the push to connect fitting is made up.

8. The push to connect fitting of claim 1 wherein said second fitting component comprises an interior groove, said interior groove comprising a first portion into which said retaining member can radially expand out of said groove in said fluid conduit and a second portion that opposes radial expansion of said retaining ring.

9. The push to connect fitting of claim 8 wherein said second fitting component comprises a first retained axial position and a second retained axial position relative to said first fitting component.

10. The push to connect fitting of claim 9 wherein at said first retained axial position said interior groove first portion will generally align radially with said conduit groove, and at said second retained axial position said interior groove second portion will generally align radially with said conduit groove, after an end of said fluid conduit has been fully inserted into said first fitting component.

11. The push to connect fitting of claim 8 wherein said interior groove second portion comprises a tapered surface that holds said retaining member against said fluid conduit outer surface when said fluid conduit is axially loaded after said second fitting component is at said second retained axial position.

12. The push to connect fitting of claim 1 wherein said second fitting component comprises a first retained axial position and a second retained axial position relative to said first fitting component.

13. The push to connect fitting of claim 12 wherein said second fitting component comprises a first retaining surface and said first fitting component comprises a second retaining surface and a third retaining surface axially separated from said second retaining surface, said first retaining surface engaging said second retaining surface when said second fitting component has been inserted into said first fitting component to said first retained axial position, and said first retaining surface engaging said third retaining surface when said second fitting component has been inserted into said first fitting component to said second retained axial position.

14. The push to connect fitting of claim 12 wherein said second fitting component is releasable from said first retained axial position and second retained axial position relative to said first fitting component.

15. The push to connect fitting of claim 14 wherein said second fitting component comprises radially compressible members that allow said second fitting component to be axially moved relative to said first fitting component.

16. The push to connect fitting of claim 1 wherein an end of said fluid conduit can be fully inserted into the push to connect fitting after said first fitting component and second fitting component have been assembled together.

17. The push to connect fitting of claim 12 wherein after said fluid conduit has been fully inserted into said first fitting component and said second fitting component has been inserted into said first fitting component to said second retained axial position, said fluid conduit is prevented in normal use from being axially withdrawn from the push to connect fitting until said second fitting component is moved to said first retained axial position.

18. A push to connect fitting for fluid conduits, comprising:
a first fitting component that can receive an end of a fluid conduit,
a second fitting component that can be axially inserted into said first fitting component to form an unthreaded mechanical connection between said first and second fitting components,
a retaining structure for releasably connecting said first fitting component and said second fitting component together, and
a seal mechanism that seals an outer surface of the fluid conduit when and end of the fluid conduit is disposed in said unthreaded mechanical connection.

19. The push to connect fitting of claim 18 comprising a conduit retainer that allows the fluid conduit to be axially withdrawn from said unthreaded mechanical connection when said second fitting component is at a first retained axial position.

20. The push to connect fitting of claim 19 wherein said conduit retainer releasably retains the fluid conduit end within said unthreaded mechanical connection when said second fitting component is at a second retained axial position.

21. The push to connect fitting of claim 1 comprising a tool that releases the fluid conduit from being retained in said unthreaded mechanical connection.

22. The push to connect fitting of claim 1 wherein said seal mechanism is integrally a part of one of said first and second fitting components.

23. The push to connect fitting of claim 1 wherein the fitting comprises a male configuration.

24. A push to connect fitting for fluid conduits, comprising:
a first fitting component that can receive an end of a fluid conduit,
a second fitting component that can be axially inserted into said first fitting component to form a threaded mechanical connection between said first and second fitting components,
a fluid conduit comprising a groove in an outer surface of the fluid conduit,
a retaining member that can be received in said fluid conduit groove,
a seal mechanism that seals an outer surface of the fluid conduit when the fluid conduit is fully inserted into said first fitting component.

25. The push to connect fitting of claim 24 wherein said groove comprises an arcuate recess.

26. The push to connect fitting of claim 24 wherein said retaining member comprises a radially expandable ring.

27. The push to connect fitting of claim 24 wherein said seal mechanism comprises an elastomer seal.

28. The push to connect fitting of claim 27 wherein said seal mechanism comprises an o-ring.

29. The push to connect fitting of claim 27 wherein said seal mechanism comprises a backing ring to reduce extrusion of said elastomer seal.

30. The push to connect fitting of claim 29 wherein said second fitting component comprises a distal end wall that supports said backing ring after the push to connect fitting is made up.

31. The push to connect fitting of claim 24 wherein said second fitting component comprises an interior groove, said interior groove comprising a first portion into which said retaining member can radially expand out of said groove in said fluid conduit and a second portion that opposes radial expansion of said retaining ring.

32. A fitting for fluid conduits, comprising:
a first fitting component, a second fitting component, wherein a mechanical connection can be made between first and second fitting components,
a fluid conduit retaining member that releasably retains said conduit as part of said mechanical connection.

33. The fitting of claim 32 wherein said conduit can be axially inserted or withdrawn from the fitting while said mechanical connection holds said first and second fitting components together.
